(19) United States
(12) Patent Application Publication
(10) Pub. No.: US 2019/0016604 A1
(43) Pub. Date: Jan. 17, 2019

(54) PRODUCTION OF FLUORINE-CONTAINING COMPOUNDS WITH THE AID OF AN ELECTROCHEMICAL MEASURING CHAIN

(71) Applicants: SOLVAY SA, Bruxelles (DE); GASKATEL GESELLSCHAFT FÜR GASSYSTEME DURCH KATALYSE UND ELEKTROCHEMIE MBH, Kassel (DE)

(72) Inventors: Hans-Joachim KOHNKE, Kassel, Bad Wilhelmshöhe (DE); Holger PERNICE, Schwanewede (DE); Andreas BECKER, Lachendorf (DE); Marc LACROIX, Ottignies - Louvain-La-Neuve (BE)

(21) Appl. No.: 15/745,231

(22) PCT Filed: Jul. 21, 2016
(86) PCT No.: PCT/EP2016/067412

§ 371 Date: Jan. 16, 2018

(30) Foreign Application Priority Data
Jul. 21, 2015 (EP) 15177757.0

(51) Int. Cl. C01F 7/54; G01N 27/416; G01N 27/30

(52) U.S. Cl. CPC C01F 7/54; G01N 27/4167; B23K 35/3605; G01N 27/302; G01N 27/301

(57) ABSTRACT

The present invention relates to processes for producing fluorine-containing compounds by means of precipitation reactions from solutions containing fluoride ions wherein the pH value is determined using an electrochemical measuring chain and to electrochemical measuring chains for determining pH values.

The present invention relates to processes for producing fluorine-containing compounds by means of precipitation reactions from solutions containing fluoride ions wherein the pH value is determined using an electrochemical measuring chain and to electrochemical measuring chains for determining pH values.

Chemical precipitation reactions for producing fluorine-containing compounds are employed industrially on a large scale. Often, the pH value over the course of the precipitation reaction is monitored and using the pH value for example the further addition of a reactant is decided upon. Hitherto, this monitoring has usually been undertaken using a pH paper and visual verification thereof. The disadvantage of this process is that it cannot be effected continuously and that the measured result may depend on the color impression of the observer, light effects and the time of reading.

The use of glass electrodes for pH measurement is likewise not practicable since these are unsuitable for use in media containing fluoride ions.

It is an object of the present invention to provide improved processes for producing fluoride-containing compounds by means of precipitation reactions from solutions containing fluoride ions. Advantageously the pH value during the precipitation reaction may be monitored more accurately. The processes according to the invention further result in a higher yield of the respective product, in an improved purity of the product, in an improved reproducibility of the process and/or in a saving of the employed amount of at least one of the reactants. The processes according to the invention further result in advantageous physicochemical properties of the respective product, for example in terms of particle size, filterability, melting point and/or storage stability.

These and other objects were achieved by the present invention.

Accordingly, the present invention relates firstly to a process for producing a fluorine-containing compound by a precipitation reaction wherein the fluorine-containing compound is precipitated from a reaction medium and that during the course of the precipitation reaction the pH value of the reaction medium is determined using an electrochemical measuring chain.

The term “fluorine-containing compound” is to be understood as meaning a chemical compound containing at least one fluorine atom. A covalently, coordinatively or ionically bonded fluorine atom may be concerned. Examples for an ionically bonded fluorine atom include the fluorine atoms of for instance a fluoride salt, a fluorozincate or a fluoroaluminate.

The fluorine-containing compound is preferably selected from the group consisting of at least one alkali metal fluoride, an alkali metal hydrogenfluoride, an alkaline earth metal fluoride, an alkaline earth metal hydrogenfluoride, a transition metal fluoride, a fluoride of an element of the third main group, an ammonium fluoride, an alkali metal fluoroaluminate, an alkaline earth metal fluoroaluminate, hydrates thereof, HF adducts thereof and mixtures thereof. The fluorine-containing compound is more preferably selected from the group consisting of KAlF₄, K₂AlF₅, K₃AlF₆, CsAlF₄, Cs₂AlF₅, Cs₃AlF₆, LiAlF₄, Li₂AlF₅, Li₃AlF₆, NaAlF₄, Na₂AlF₅, Na₃AlF₆, KBF₄, BaF₂, KHF₂, NH₄F, NH₄F₂, hydrates thereof, HF adducts thereof and mixtures thereof, particularly preferably from the group consisting of KAlF₄, K₂AlF₅, K₃AlF₆, hydrates thereof and mixtures containing KAlF₄, K₂AlF₅, K₃AlF₆ and/or hydrates thereof.

Especially preferred is a mixture having the empirical chemical formula K₁₋₃AlF₄₋₆ which is used as flux and is produced by Solvay Fluor GmbH under the name NOCOLOK®. In this special embodiment aqueous 5% to 60% hydrofluoric acid (HF), preferably 20% to 30% hydrofluoric acid (HF), is reacted with aluminum hydroxide and the resulting solution containing aqueous fluoroaluminic acid is subsequently admixed with an aqueous solution of KOH, thus resulting in precipitation of the desired product K₁₋₃AlF₄₋₆. During the addition of the KOH solution the pH value is checked by means of the electrochemical measuring chain and the addition of the KOH solution may be adjusted in terms of the added amount such that the resulting product reproducibly exhibits advantageous properties.

According to the special embodiment recited above it is also possible to produce the products likewise usable as fluxes and/or as products for flame soldering Cs₁₋₃AlF₄₋₆ by addition of a corresponding CsOH solution; Na₁₋₃AlF₄₋₆ by addition of a corresponding NaOH solution; and Li₁₋₃AlF₄₋₆ by addition of the corresponding LiOH solution. In turn during the addition of the hydroxide solution the pH value is checked by means of the electrochemical measuring chain and the addition is adjusted such that the resulting product reproducibly exhibits advantageous properties.

In a further special embodiment an aqueous solution or suspension of ZnO and HF is produced and subsequently with pH verification with an electrochemical measuring chain admixed with an aqueous KOH solution. Alternatively, a ZnO suspension is initially charged and admixed with an aqueous KF solution. In turn during the addition of the second solution in each case the pH value is checked by means of the electrochemical measuring chain and the addition is adjusted such that the resulting product KZnF₃ reproducibly exhibits advantageous properties.

In a further special embodiment an aqueous solution or suspension of BaCO₃ is reacted with hydrofluoric acid to afford BaF₂, wherein the pH value of the reaction solution is checked by means of the electrochemical measuring chain.

In a further special embodiment an aqueous ammonia solution is reacted with hydrofluoric acid to afford NH₄F.HF, wherein the pH value of the reaction solution is checked by means of the electrochemical measuring chain.

The term “precipitation reaction” is to be understood as meaning a chemical reaction in the course of which the desired chemical compound is formed and at least partly either continuously in the course of the chemical reaction precipitates from the reaction medium as solid or subsequently to the chemical reaction, preferably initiated by a further chemical and/or physicochemical manipulation, precipitated.

The precipitation reactions may be performed for example in a temperature range from −50° C. to 250° C. Said reactions are preferably performed at from 0° C. to 100° C., particularly preferably in a range from 10° C. to 90° C., especially in a range from 80° C. to 90° C., at room temperature, or at ambient temperature.

It is preferable when the reaction medium contains fluoride ions at commencement of the precipitation reaction and hydroxide ions are added to the reaction medium during the precipitation reaction. It is likewise preferable when the reaction medium contains hydroxide ions at commencement of the precipitation reaction and fluoride ions are added to the reaction medium during the precipitation reaction.

The pH value of the reaction medium is determined at least once in the course of the precipitation reaction. It is preferable when the pH value is continuously monitored using an electrochemical measuring chain. It is likewise preferable when the pH value is determined after each addition of a reaction partner and/or discontinuously at set times.

The addition of further amounts of the reaction partners during the course of the precipitation reaction is preferably controlled by the pH value determined using the electrochemical measuring chain, i.e. the process is run as a so-called “closed-loop” process. The further addition of at least one reaction partner is thus automatically controlled by the pH value of the reaction medium. Alternatively, the addition may be effected manually according to the determined pH value.

The term “reaction partner” is to be understood as meaning the reactant(s) added to the reaction solution. The addition of the reaction partner may take place in pure form, preferably the reaction partner is added as a solution, particularly preferably an aqueous solution. An individual chemical compound may be concerned here. Alternatively, the term “reaction partner” is to be understood as meaning a mixture of at least two chemical compounds.

It is likewise preferable when the further addition of the reaction partner is terminated as soon as the pH value determined by the electrochemical measuring chain achieves a value of 2.5 to 7, preferably 3.0 to 5.0, more preferably 3.5 to 4.5.

The accurate monitoring of the pH value of the reaction medium in the course of the precipitation reaction allows the produced chemical compounds to be produced reproducibly in novel qualities with precisely adjusted chemical and physicochemical properties. Accordingly, the present invention further relates to a fluorine-containing compound produced by the process described hereinabove.

The employed electrochemical measuring chain generally consists of two electrodes which are preferably constructionally integrated in a housing. DE 10 2011 113 941 A1 describes an electrochemical measuring chain suitable in principle for measurements in fluoride-containing solutions and for the processes according to the invention. However, one problem is that as a result of the diaphragm 14 in DE 10 2011 113 941 A1 reaction medium may partially penetrate into the region comprised by the electrode housing 1. This can result in a chemical reaction between components of the electrolyte in contact with the gas diffusion electrode 8 and components from the reaction medium. The products of these chemical reactions can then result in a blockage of the diaphragm 14. Furthermore the penetration of the reaction medium can falsify the measured value. Accordingly, the present invention further relates to an electrochemical measuring chain containing at least one hydrogen gas diffusion electrode 7 and at least one reference electrode 8, wherein these electrodes can form a constructional unit in a housing 1 having an outlet 14 and wherein the housing 1 comprises a reference electrolyte 11 in contact with the reference electrode 8 and a sealed-off gas space 19 above the reference electrolyte 11.

The sealed-off gas space 19 above the reference electrolyte ensures that a certain amount of the reference electrolyte 11 continuously effluxes through the outlet 14 and thus that penetration of measurement medium 9 through the outlet 14 is prevented. At least the problems as described hereinabove for the measuring chain from DE 10 2011 113 941 A1 are thus solved and an enhanced measuring accuracy achieved. It is furthermore achieved that the efflux of reference electrolyte 11 through the outlet 14 may be and precisely controlled for example via the gas volume that is passed into the gas space 19 and generated in the galvanic cell 3 in the hermetically sealed-off chamber 2, so that a contamination of the measurement medium 9, i.e. for example of the reaction medium of the process according to the invention, may be precisely determined and thus minimized.

A further advantage of the electronic measuring chain according to the invention is that it may be employed for measuring the pH value in nonaqueous media, for example in organic solvents, and in liquid or semiliquid media such as are used in the foodstuffs industry.

The housing 1 is advantageously made of a material inert toward most chemicals. Plastics such as PTFE, Teflon®, PP, FEP, PFA, PEEK, PE and PMMA are advantageous. The sealed-off gas space 19 is located above the reference electrolyte 11 inside the housing 1. The term “sealed-off” is to be understood as meaning that a certain pressure, for example a pressure that is slightly elevated compared to ambient pressure, may advantageously be established. Nevertheless, it will be appreciated that the portion of the housing 1 which seals off the gas space 19 may contain openings which, however, are sealed during the measuring operation, thus in turn sealing off the gas space. For example the housing 1 may have openings for feeding reference electrolyte, for a fill level indicator and/or control means, for an overpressure valve or for measuring instruments in the housing 1. The hydrogen gas diffusion electrode 7 is in contact with the measurement medium and serves as an indicator electrode. Said electrode is provided with hydrogen by at least one hydrogen-developing cell 3, for example according to DE 3532335, located in chamber 2, by gas efflux opening 5 and a thin bore 6. In order that the at least one hydrogen-developing cell 3 may operate in a controlled fashion said cell is discharged via at least one resistance means 4. The sealed-off chamber 2 prevents entry of atmospheric oxygen or uncontrolled escape of hydrogen. Alternatively, a controlled amount of hydrogen may be fed into the chamber 2 via a mass flow controller for example. The potential established at the electrode 7 is sent on to the contact 10 via a palladium wire for example. The measured potential difference (in mV) is used for conversion into a pH value. The electrochemical measuring chain may advantageously be used in systems in which the fluoride concentration is more than 1% by weight, more than 5% by weight, more than 10% by weight or even more than 20% by weight, for example 50% by weight. The electrochemical measuring chain also has the particular feature that it provides reliable measured results even at a fluoride concentration of more than 1% by weight, more than 5% by weight, more than 10% by weight or even more than 20% by weight, for example 50% by weight. Reliable measured results may in particular be achieved at fluoride concentrations recited above and high temperatures, for instance at 40° C. or more, 50° C. or more, 60° C. or more or even 70° C. or more without appreciable attack of the measuring chain. Under these conditions known electrochemical measuring chains cannot operate, in particular not as a measuring chain for monitoring the pH value inside a chemical process under industrial conditions. When the measuring chain is employed in chemical precipitation reactions for producing fluorine-containing compounds these are preferably performed at temperatures of 0° C. to 100° C., particularly preferably in a range from 10° C. to 90° C., specifically in a range from 80° C. to 90° C., at room temperature, or at ambient temperature.

The electrochemical measuring chain further comprises at least one reference electrode 8 which is in contact with the reference electrolyte 11. The potential established at the electrode 8 is sent on to the contact 13 via a palladium wire for example. Alternatively, the electrochemical measuring chain comprises two or more reference electrodes. It is preferable when at least one reference electrode is a hydrogen gas diffusion electrode 8 having the contact 13 or an Ag/AgCl electrode comprising an Ag wire 18 and an AgCl layer 17 having the contact 12. A hydrogen gas diffusion electrode 8 is particularly preferred. It is likewise preferable when the electrochemical measuring chain comprises one of each of a hydrogen gas diffusion electrode and an Ag/AgCl electrode which are both in contact with the reference electrolyte 11. An electrolytic connection between the reference electrolyte 11 and the measurement medium 9 is produced via the outlet 14. The outlet 14 may be one or more diaphragms, one or more annular gaps or one or more holes.

It is further advantageous when the housing 1 comprises a respective temperature sensor 15 having a respective connection 16, one sensor being in contact with the measurement medium and one sensor being in contact with the reference electrolyte. In order that an evaluation of the measurements from the electrochemical measuring chain according to the Nernst equation is possible all relevant components (indicator electrode, reference electrode) should as far as possible have the fewest possible differences and, especially, known temperatures. If this is not the case significant deviations between the measured voltage in millivolts and the pH value calculated therefrom can result. Accordingly, the housing advantageously comprises a heat transferor which can regulate the temperature of the reference electrolyte 11 and/or of the housing 1. In the simplest case the heat transferor is a heating coil, a cooling means (e.g. Peltier element) or a combined cooling/heating coil submerged in the reference electrolyte 11.

The reference electrolyte is preferably an aqueous solution of at least one metal salt. Aqueous solutions of halogen metal salts of the first or second main group of the periodic table, for example an aqueous KCl or CsCl solution, are particularly preferred.

It is further advantageous when the housing 1 comprises one or more fill level indicators which indicate the amount of reference electrolyte 11 present. The fill level indicator may be, inter alia, of a purely optical nature in the form of a sight glass, of a photo-optical nature, of a mechanical nature, of an acoustic nature or of an electronic nature, for example by measurement of resistance. Thus the filling level of reference electrolyte 11 may be controlled manually or automatically according to the result of the fill level indicator so that an uncovering of the at least one reference electrode is prevented.

### LIST OF REFERENCE NUMERALS

1 (rod-shaped) housing
2 sealed-off chamber
3 galvanic cell
4 resistance means
5 gas efflux opening
6 thin bore
7 hydrogen gas diffusion electrode as indicator electrode
8 hydrogen gas diffusion electrode as reference electrode
9 measurement medium
10 contact
11 reference electrolyte
12 Ag/AgCl electrode contact
13 hydrogen gas diffusion electrode contact
14 outlet opening
15 temperature sensors
16 electrical connections
17 AgCl layer on Ag/AgCl reference electrode
18 Ag wire of Ag/AgCl reference electrode
19 sealed-off gas space above 11

### WORKING EXAMPLES

### Example 1—Production of a Soldering Flux

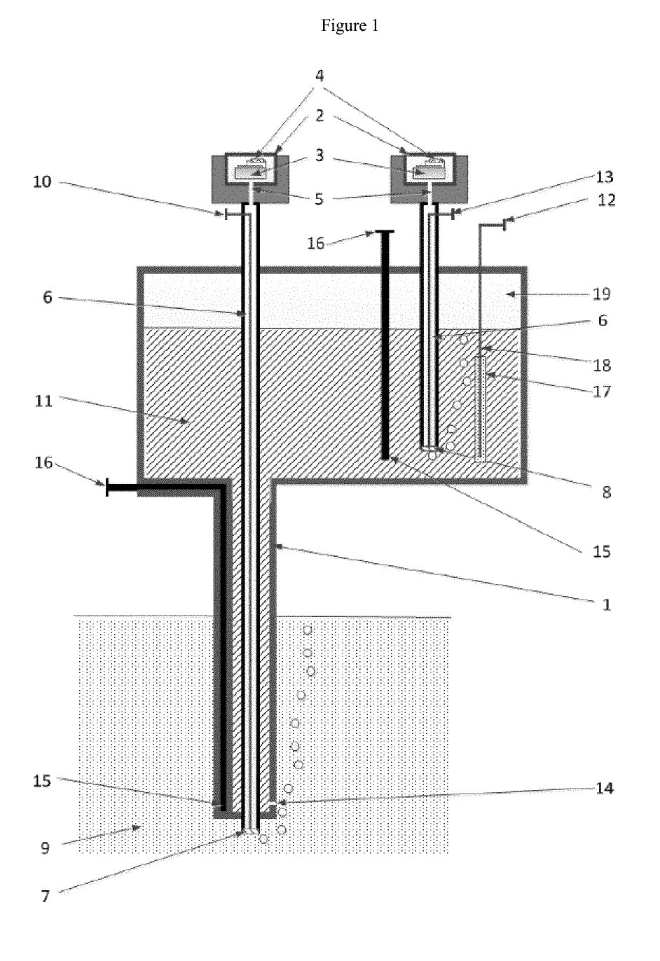

614 kg of hydrogen fluoride in the form of a hydrofluoric acid containing 20% by weight of hydrogen fluoride and 550 kg of aluminum hydroxide (99% purity) are reacted to form a fluoroaluminic acid in a stirred reactor fitted with the electrochemical measuring chain according to FIG. 1. At a temperature of 80° C. in the reactor and a temperature of 50° C. in the reference electrolyte 11, the reference electrolyte 11 consisting of an aqueous KCl solution, the obtained reaction mixture is admixed with a potassium hydroxide solution containing 15% by weight of KOH which was obtained by dissolution of 550 kg of KOH. A suspension of precipitating potassium salts of complex aluminum fluorides is formed. During the addition of potassium hydroxide solution the pH value is continuously monitored using the electrochemical measuring chain and the addition of potassium hydroxide solution is terminated upon achieving a pH value of 4.0. The product formed is filtered and the filter-damp residue is dried in a flow dryer at 570° C. The described process results in an advantageous filterability of the suspension and higher yield and purity of the resulting product. The process further results in a saving of hydrofluoric acid and potassium hydroxide solution since the additions of hydrofluoric acid and potassium hydroxide solution can be terminated with pinpoint accuracy resulting in neither underproduction nor overproduction.

### Example 2—Production of a Soldering Flux

614 kg of hydrogen fluoride in the form of a hydrofluoric acid containing 50% by weight of hydrogen fluoride and 550 kg of aluminum hydroxide (99% purity) are reacted to form a fluoroaluminic acid in a stirred reactor. The stirred reactor is fitted with a bypass which is equipped with an electrochemical measuring chain according to FIG. 1 and through which by means of a pump the reaction mixture is withdrawn from the stirred reactor and after measurement by means of said electrochemical measuring chain according to FIG. 1 released back into the stirred reactor. At a temperature of 80° C. in the bypass and in the stirred reactor and a temperature of 50° C. in the reference electrolyte 11, the reference electrolyte consisting of an aqueous KCl solution, the obtained reaction mixture is admixed with a potassium hydroxide solution containing 15% by weight of KOH which was obtained by dissolution of 550 kg of KOH. A suspension of precipitating potassium salts of complex aluminum fluorides is formed. During the addition of potassium hydroxide solution the pH value is continuously monitored using the electrochemical measuring chain and the addition of potassium hydroxide solution is terminated upon achieving a pH value of 4.5. The product formed is filtered and the filter-damp residue is dried in a flow dryer at 570° C. The described process results in an advantageous filterability of the suspension and higher yield and purity of the resulting product. The process further results in a saving of hydrofluoric acid and potassium hydroxide solution since the additions of hydrofluoric acid and potassium hydroxide solution can be terminated with pinpoint accuracy resulting in neither underproduction nor overproduction. The use of a bypass furthermore results in a markedly smaller construction of the electrochemical measuring chain according to FIG. 1.

1. A process for producing a fluorine-containing compound by a precipitation reaction, wherein the fluorine-containing compound is precipitated from a reaction medium and wherein during the course of the precipitation reaction the pH value of the reaction medium is determined using an electrochemical measuring chain.

2. The process as claimed in claim 1 wherein the fluorine-containing compound is selected from the group consisting of at least one alkali metal fluoride, an alkali metal hydrogenfluoride, an alkaline earth metal fluoride, an alkaline earth metal hydrogenfluoride, a transition metal fluoride, a fluoride of an element of the third main group, an ammonium fluoride, an alkali metal fluoroaluminate, an alkaline earth metal fluoroaluminate, hydrates thereof, HF adducts thereof and mixtures thereof.

3. The process as claimed in claim 1 wherein the fluorine-containing compound is selected from the group consisting of KAlF₄, K₂AlF₅, K₃AlF₆, CsAlF₄, Cs₂AlF₅, Cs₃AlF₆, LiAlF₄, Li₂AlF₅, Li₃AlF₆, NaAlF₄, Na₂AlF₅, Na₃AlF₆, KBF₄, BaF₂, KHF₂, NH₄F, NH₄F₂, hydrates thereof, HF adducts thereof and mixtures thereof.

4. The process as claimed in claim 1 wherein the reaction medium contains fluoride ions at commencement of the precipitation reaction and hydroxide ions are added to the reaction medium during the precipitation reaction.

5. The process as claimed in claim 1 wherein the reaction medium contains hydroxide ions at commencement of the precipitation reaction and fluoride ions are added to the reaction medium during the precipitation reaction.

6. The process as claimed in claim 1 wherein the fluoride-containing compound is selected from the group consisting of KAlF₄, K₂AlF₅, K₃AlF₆, hydrates thereof and mixtures containing KAlF₄, K₂AlF₅, K₃AlF₆ and/or hydrates thereof, the reaction medium contains fluoroaluminic acid at commencement of the precipitation reaction and the precipitation reaction is effected by addition of an aqueous potassium hydroxide solution to the reaction medium.

7. The process as claimed in claim 1 wherein the addition of the reaction partner is terminated as soon as the pH value in the reaction medium determined by the electrochemical measuring chain achieves a value of 2.5 to 7.

8. The process as claimed in claim 1 wherein the addition of the reaction partner during the course of the precipitation reaction is controlled by the pH value determined using the electrochemical measuring chain.

9. A fluorine-containing compound produced by the process according to claim 1.

10. An electrochemical measuring chain containing a hydrogen gas diffusion electrode 7 as an indicator electrode and at least one reference electrode, wherein the electrodes form a constructional unit with a housing 1 having an outlet 14 and wherein the housing 1 comprises a reference electrolyte 11 in contact with the reference electrode and a sealed-off gas space 19 above the reference electrolyte 11.

11. The electrochemical measuring chain as claimed in claim 10 wherein the at least one reference electrode comprises a hydrogen gas diffusion electrode 8 or an Ag/AgCl electrode 17, preferably a hydrogen gas diffusion electrode 8.

12. The electrochemical measuring chain as claimed in claim 10 wherein the housing 1 comprises a temperature sensor 15 in contact with the reference electrolyte 11 and a temperature sensor 15 in contact with the measurement medium 9.

13. The electrochemical measuring chain as claimed in claim 10 comprising a hydrogen gas diffusion reference electrode 8 and an Ag/AgCl reference electrode 8.

14. The electrochemical measuring chain as claimed in claim 10 wherein the temperature of the reference electrolyte may be controlled by means of a heat transferor.

15. A measuring instrument containing the electrochemical measuring chain according to claim 10.

16. The process as claimed in claim 3 wherein the fluorine-containing compound is selected from the group consisting of KAlF₄, K₂AlF₅, K₃AlF₆, hydrates thereof and mixtures containing KAlF₄, K₂AlF₅, K₃AlF₆ and/or hydrates thereof.

17. The process as claimed in claim 7 wherein the addition of the reaction partner is terminated as soon as the pH value in the reaction medium determined by the electrochemical measuring chain achieves a value of 3.0 to 5.0.

18. The process as claimed in claim 17 wherein the addition of the reaction partner is terminated as soon as the pH value in the reaction medium determined by the electrochemical measuring chain achieves a value of 3.5 to 4.5.

19. The electrochemical measuring chain as claimed in claim 10, wherein the reference electrolyte is an aqueous solution of at least one metal salt.

20. The electrochemical measuring chain as claimed in claim 19, wherein the at least one metal salt is a halogen metal salt of the first or second main group of the periodic table.
